(19) United States
(12) Patent Application Publication
(10) Pub. No.: US 2017/0194096 A1
(43) Pub. Date: Jul. 6, 2017

(54) WIRE SPOOL STRUCTURE FOR FACILITATED WIRE WINDING AND WIRE WINDING METHOD THEREOF

(71) Applicant: INNOTRANS TECHNOLOGY CO., LTD., Taipei (TW)

(72) Inventor: Tsung-Han CHOU, Keelung (TW)

(21) Appl. No.: 15/264,153

(22) Filed: Sep. 13, 2016

Related U.S. Application Data
(62) Division of application No. 14/988,288, filed on Jan. 5, 2016.

(51) Int. Cl. H01F 41/06; H01F 27/29; H01F 27/28; B65H 54/02; B23K 31/02

(52) U.S. Cl. CPC H01F 41/06; B65H 54/02; B23K 31/02; H01F 27/2823; H01F 27/292; B65H 2701/36

(57) ABSTRACT

A wire spool structure for facilitated wire winding includes: at least one wire winding portion; a plurality of wire exit portions, each including a channel, which penetrates the wire exit portion, and includes at least one exit and a bridge pin integrally extended and formed from the wire exit portion and located at the exit of the channel to allow a wire to be wound thereon; and a plurality of conductive pins, disposed correspondingly to the wire exit portions, respectively, each including an installation section and a wire connecting section connected to the wire installation section. After an end of the wire is wound on the bridge pin, each conductive pin is inserted into the channel such that the wire connecting section protrudes from the exit and is welded with the wire by a welding material to form an electrical connection.

### CROSS REFERENCE TO RELATED APPLICATIONS

This application is a Divisional of co-pending application Ser. No. 14/988,288, filed on 5 Jan. 2016, for which priority is claimed under 35 U.S.C. §120; the entire contents of all of which are hereby incorporated by reference.

### FIELD OF THE INVENTION

The present invention relates to a wire spool structure for facilitated wire winding and a wire winding method thereof.

### BACKGROUND OF THE INVENTION

Current wire spool structures, such as disclosures of the Taiwan Patent Nos. 1501266, 1493578, 1471879, M502237 and M491933, usually include a wire winding portion and a plurality of wire exit portions. The wire winding portion allows at a least one wire to be wound thereon. Each of the wire exit portions includes a plurality of fixed conductive pins. After the wire is completely wound, an end of the wire may be placed in the exit portion and be welded with the conductive pin to form an electrical connection. However, in current wire spool structures, the conductive pins are fixedly provided on the wire spool structure after the wire spool structure is manufactured. As such, during a wire winding process, a user needs to particularly pay attention to positions of the conductive pins, and to whether these conductive pins properly coordinate with currently used wire winding tools. Such complications disfavor the application of the conventional wire spool structure.

The Applicant previously raised a coil winding structure including an aluminum conductor, as disclosed by the Taiwan Patent No. 1501270. The coil winding structure includes a wire spool, at least one aluminum conductor, and a plurality of copper inserting members. The wire spool includes at least one wire winding region. The aluminum conductor includes a coil winding section that surrounds the wire winding region by at least one turn, and two connecting sections at ends of the aluminum conductor. Each of the copper inserting members includes a clamping portion covering the connecting section, and an inserting portion inserted into a connecting hole. During an application of a winding process, the aluminum conductor is first wound for at least one turn at the wire winding region, and the end of the aluminum conductor is assembled with the copper inserting member. The copper inserting member may be installed on the wire spool in advance, or may be installed on the wire spool after having been assembled with the aluminum conductor. If the copper inserting member is installed on the wire spool in advance, during the application of the winding process, the wire spool is affected by the copper inserting members to result in the foregoing issue of a disfavored winding process. If the copper inserting member is installed on the wire spool after having been assembled with the aluminum conductor, the aluminum conductor requires a longer reserved segment for the user to readily connect the aluminum conductor with the copper inserting member. Thus, the segment having an excessively reserved length may cause lax coil winding and affect electrical characteristics. In addition, the above implementation is unsuitable for a wire spool having a minute size or including a large number of pins, hence leading in application limitations.

Thus, in an application of a winding process of conventional wire spool structures, these wire spool structures are generally limited by conductive pins, such that the winding process cannot be smoothly performed.

### SUMMARY OF THE INVENTION

The primary object of the present invention is to solve the winding issue caused by conductive pins in a conventional wire spool structure.

To achieve the above object, the present invention provides a wire spool structure for facilitated wire winding. The wire spool structure includes a wire winding portion, a plurality of wire exit portions, and a plurality of conductive pins. The wire winding portion is operable to be wound by at least one wire. The wire exit portions are connected to one side of the wire winding portion. Each of the wire exit portions includes a channel that penetrates the wire exit portion and has at an exit, and at least one bridge pin integrally extended and formed from the wire exit portion and located at the exit of the channel to allow the wire to be wound thereon. The conductive pins are disposed correspondingly to the wire exit portions, respectively. Each of the conductive pins includes an installation section and a wire connecting section connected to the installation section. After the wire is wound at the bridge pin, each of the conductive pins is inserted into the channel to locate the installation section in the channel, such that the wire connecting section protrudes from the exit to become disposed correspondingly to the bridge pin and is welded with the wire by a welding material to form an electrical connection.

In one embodiment, the wire spool structure is formed by two half housings, and the wire winding portion and the wire exit portions are jointly defined and formed by the two half housings.

In one embodiment, each of the wire exit portions includes a plurality of the bridge pins disposed in a surrounding and spaced manner at the exit of the channel.

In one embodiment, each of the wire exit portions corresponding to the exit of the channel includes two of the bridge pins. The two bridge pins are disposed at two opposite surfaces of the exit, and jointly support the wire connecting section after the conductive pin is inserted into the channel.

The present invention further provides a wire winding method of a wire spool structure. The method includes steps of material preparation, wire winding, conductive pin inserting and welding.

In the material preparation step, a wire spool structure is provided. The wire spool structure includes at least one wire winding portion, a plurality of wire exit portions and a plurality of conductive pins. Each of the wire exit portions includes a channel penetrating through the wire exit portion and having at an exit, and at least one bridge pin integrally extended and formed from the wire exit portion and located at the exit of the channel to allow the wire to be wound thereon.

In the wire winding step, a wire is provided and wound around the wire exit portion for at least one turn, and an end of the wire is caused to be wound on the bridge pin.

In the conductive pin inserting step, one of the conductive pins is inserted into the channel to locate an installation section of the conductive pin in the channel, and to cause a wire connecting section of the conductive pin to protrude from the exit and be disposed correspondingly to the bridge pin.

In the welding step, the wire connecting section of the conductive pin and the wire are welded to form an electrical connection.

In one embodiment, between the conductive pin inserting and welding steps, the method further includes a pin position adjusting step, in which the conductive pin is caused to protrude from the channel towards the bridge pin to be able to be connected to a circuit board.

With the above technical solutions of the present invention, the present invention provides following features compared to the prior art. In the present invention, in addition to including the conductive pin, each of the wire exit portions further includes the bridge pin. The bridge pin includes the channel penetrating the wire exit portion and having at least one exit that allows the conductive pin to be moved therein, and at least one bridge pin integrally extended and formed from the wire exit portion and located at the exit of the channel. Only after the wire is wound at the wire winding portion, the conductive pin is inserted into the channel to locate the installation section of the conductive pin in the channel, such that the wire connecting section of the conductive pin protrudes from the exit and is disposed correspondingly to the bridge pin, and the wire then later welded with the wire connecting section to form an electrical connection. Thus, during the application of the wire winding process, a user is capable of smoothly implementing the wire winding process without having to consider the position of the conductive pin.

### BRIEF DESCRIPTION OF THE DRAWINGS

FIG. 1 is an appearance schematic diagram according to an embodiment of the present invention;

FIG. 2 is an exploded view according to an embodiment of the present invention;

FIG. 3 is a sectional view according to an embodiment of the present invention;

FIG. 4 is a flowchart of a method according to an embodiment of the present invention;

FIG. 5 is a first sectional view of an implementation process according to an embodiment of the present invention;

FIG. 6 is a second sectional view of an implementation process according to an embodiment of the present invention;

FIG. 7 is a flowchart of a method according to another embodiment of the present invention; and

FIG. 8 is sectional view of an implementation process according to another embodiment of the present invention.

### DETAILED DESCRIPTION OF THE PREFERRED EMBODIMENTS

Details and technical contents of the present invention are given with the accompany drawings below.

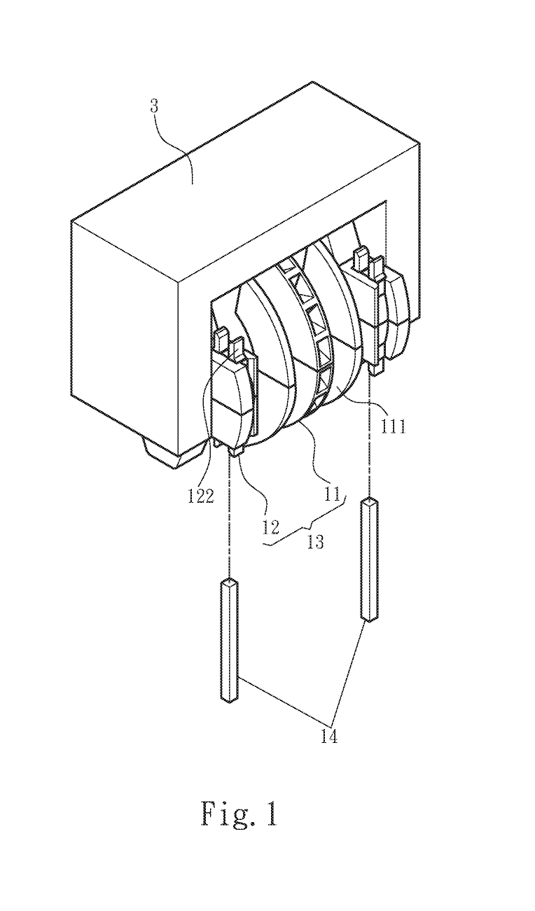

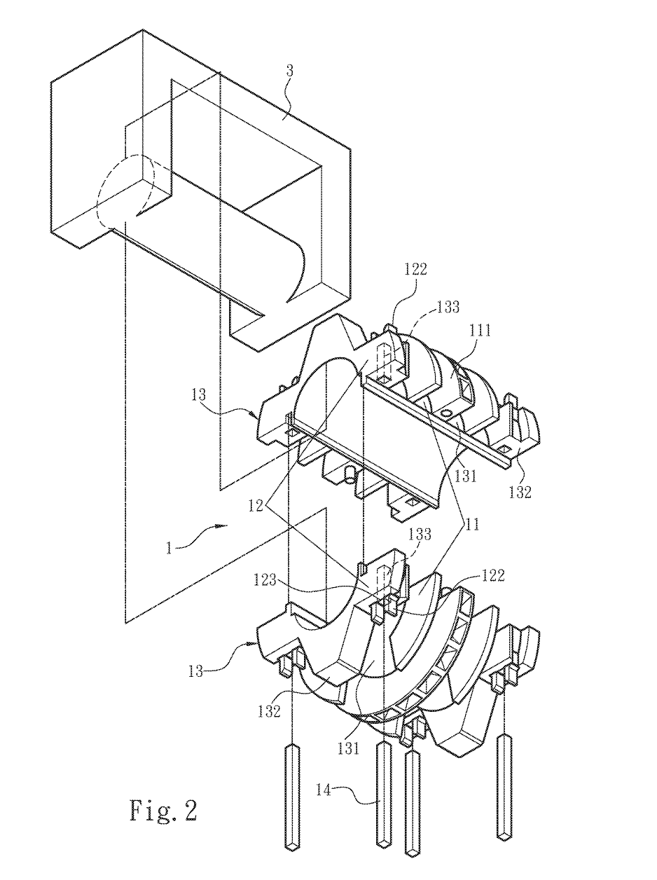

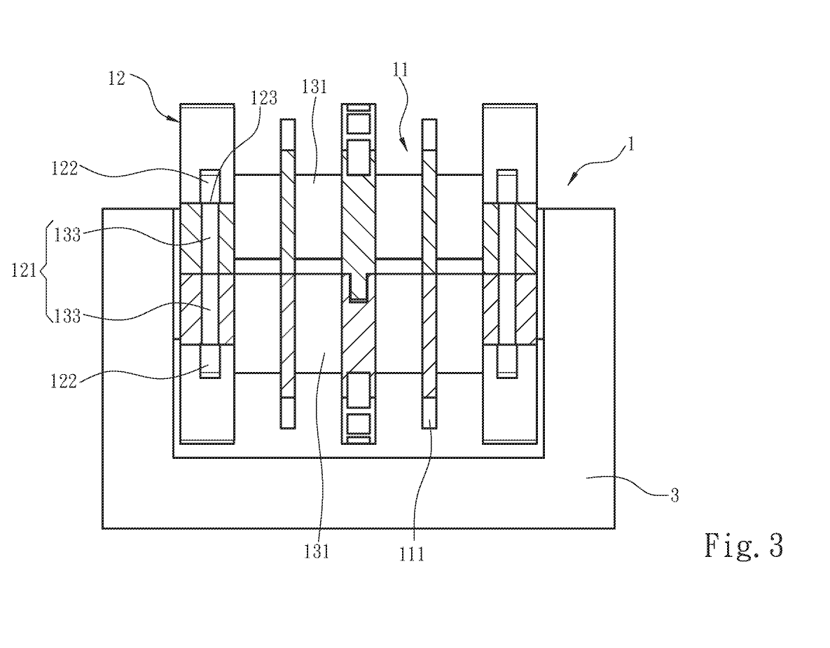

Referring to FIG. 1 to FIG. 3, the present invention provides a wire spool structure 1 for facilitated wire winding. The wire spool structure 1 is operable for a wire 2 to be wound thereon, and may be assembled with a core 3 to form a magnetic element. For example, the magnetic element is a transformer or an inductor. In the drawings, the wire spool structure 1 of the present invention is applied in an implementation of a transformer as an example to explain the present invention rather than a limitation to the present invention. The wire spool structure 1 of the present invention includes at least one wire winding portion 11, a plurality of wire exit portions 12 connected to one side of the wire winding portion 11, and a plurality of conductive pins 14. The wire winding portion 11 allows at least one wire 2 to be wound thereon, and the wire 2 may be wound on the wire winding portion 11 for at least one turn according to application requirements. Further, the wire winding portion 11 may be formed with at least one partitioning plate 111, which divides the wire winding portion 11 into a plurality of winding regions. Each of the winding regions allows the wire 2 to be wound therein to form a plurality of wire coils. Further, the thickness or shape of the partitioning plate 111 may be appropriately adjusted according to the insulation safety regulation requirements of the transformer.

The wire exit portions 12 are connected to one side of the wire winding portion 11. When the wire spool structure 1 includes a plurality of the wire exit portions 12, the wire exit portions 12 are located at two sides of the wire winding portions 11. Each of the wire exit portions 12 includes a channel 121 and a bridge pin 122. The channel 121 penetrates the wire exit portion 12 along an axial direction, and includes at least one exit 123. The bridge pin 122 is integrally extended and formed from the wire exit portion 12, and is located at the exit 123 of the channel 121. The bridge pin 122 is in fact a part of the wire exit portion 12. That is to say, after the wire spool structure 1 is manufactured by a mechanical process such as injection, the bridge pin 122 is disposed on the wire exit portion 12. It should be noted that, in the present invention, the bridge pin 122 serves for wire winding and bridging purposes and is not electrically conductive, and is thus different from the conductive pins 14. The presence of the bridge pin 122 is to allow the end of the wire 2 to be first wound on the bridge pin 122 after the wire 2 is wound and before the wire 2 is welded with the conductive pin 14, so as to solve the issue that a conventional conductive pin generates during the wire winding process. In one embodiment, each of the wire exit portions 12 includes a plurality of the bridge pins 122, which are disposed correspondingly to the exit 123 of the channel 121. Further, the bridge pins 122 facing the same exit 123 are arranged at the exit 123 in a surrounding and spaced manner In one embodiment, each of the wire exit portions 12 corresponding to the exit 123 of the channel 121 includes two bridge pins 122. The two bridge pins 122 are disposed at two opposite surfaces of the exit 123, respectively, and jointly support the conductive pin 14 protruding from the channel 121. Further, the implementation form of the bridge pin 122 may be correspondingly adjusted according to application requirements, and is not limited to the examples described or depicted in the drawings.

In the present invention, each of the conductive pins 14 is disposed correspondingly to one of the wire exit portions 12, and may be configured to insert into the channel 121 to perform appropriate movements when receiving a force. Each of the conductive pins 14 includes an installation section 141 and a wire connecting section 142 connected to the installation section 141. Further, the form of the conductive pins 14 may be appropriately adjusted according to the implementation form of the channel 121. However, the form of the conductive pins 14 is not limited to that matching the implementation form of the channel 121. More specifically, in the present invention, to allow each of the conductive pins 14 to smoothly insert into the channel 121, the diameter or size of each conductive pin 14 is configured to at least match an inner diameter of the channel 121. Moreover, in the present invention, each conductive pin 14 is not disposed in the channel 121 at an initial stage of wire winding, and is inserted into the channel 121 only during the wire winding process.

Again referring to FIG. 1 to FIG. 3, in one embodiment, the wire spool structure 1 is formed by two half housing 13, which jointly define and form the wire winding portion 11 and the wire exit portions 12. More specifically, the two half housings 13 are corresponding structures. Each of the two half housings 13 includes a semi-ring 131 and two seats 132 respectively connected to the sides of the semi-ring 131. Each seat 132 includes a through hole 133. Thus, when the two half housings 13 are assembled to each other, the two semi-rings 131 jointly form the wire winding portion 11, the seats 132 jointly form the wire exit portions 12, and the two corresponding through holes 133 assembled become in communication with one each other and form the channel 121.

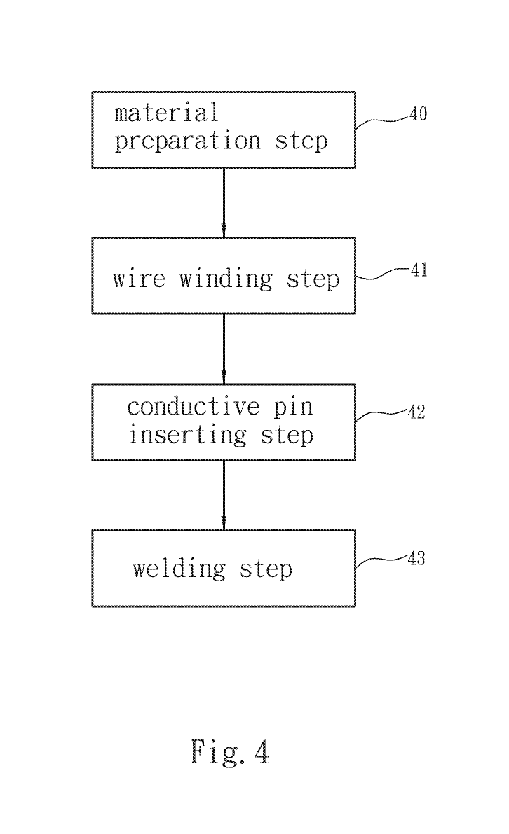

Referring to FIG. 4 to FIG. 6, the present invention further discloses a wire winding method of the wire spool structure. The wire wining method includes following steps.

In a material preparation step 40, the wire spool structure 1 is provided. The wire spool structure 1 includes the at least one wire winding portion 11, the plurality of wire exit portions 12 and the plurality of conductive pins 14. Each of the wire exit portions 12 includes the channel 121 and the at least one bridge pin 122. The channel 121 penetrates the wire exit portion 12, and includes the at least one exit 123. The bridge pin 122 is integrally extended and formed from the wire exit portion 12, and locates at the exit 123 of the channel 121 to allow the wire 2 to be wound thereon.

In a wire winding step 41, the wire 2 is wound for at least one turn on the wire exit portion 12, and the end of the wire 2 is wound on the bridge pin 122.

In a conductive pin inserting step 42, one of the conductive pins 14 is inserted into the channel 121, such that the installation section 141 of the conductive pin 14 is placed at the channel 121, and the wire connecting section 142 of the conductive pin 14 protrudes at the exit 123 and is disposed correspondingly to the bridge pin 122.

In a welding step 43, the wire connecting section 142 of the conductive pin 14 is welded with the wire 2 by a welding material 6 to form an electrical connection.

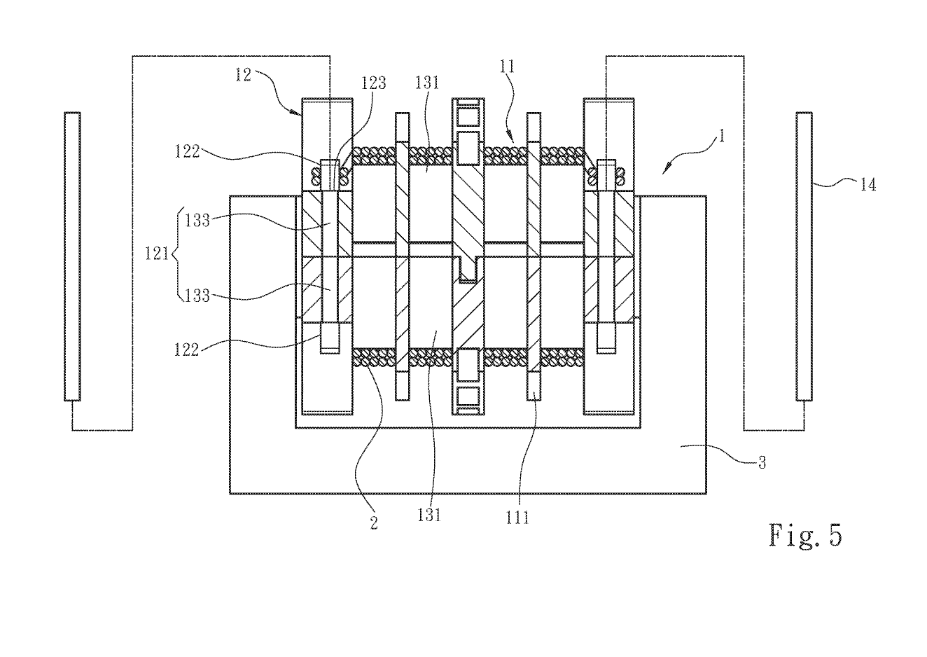

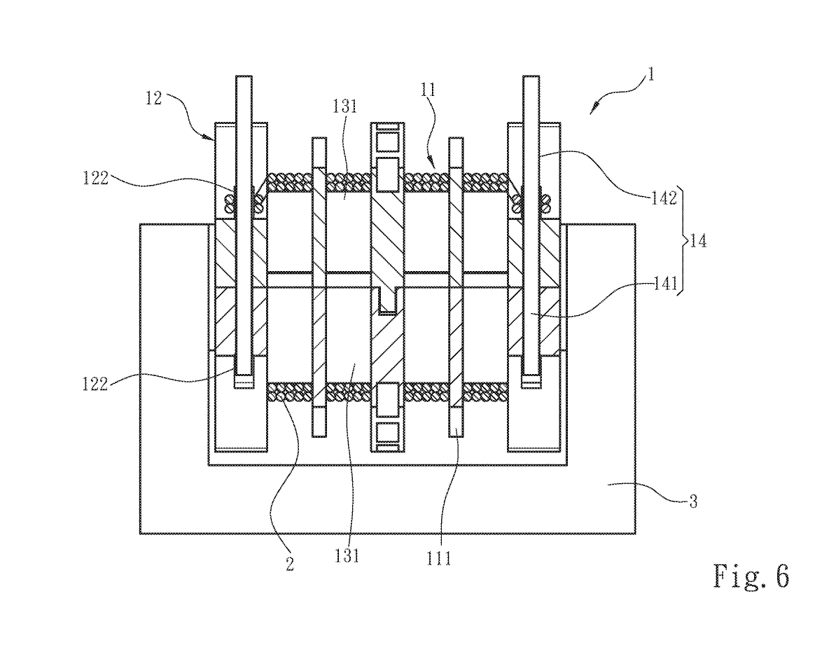

More specifically, during an initial stage of the wire winding method, the wire spool structure 1 is provided and the wire winding step 41 is performed. That is, the wire 2 is wound for at least one turn on the wire winding portion 11, and the end of the wire 2 is wound on the bridge pin 122 to settle the wire 2, so as to further proceed to the conductive pin inserting step 42. At the beginning of the conductive pin inserting step 42, one of the conductive pins 14 is caused to be disposed correspondingly to the wire exit portion 12 wound with the end of the wire 2. The conductive pin 14 is then placed into the channel 121, and controlled to protrude towards the direction of the bridge pin 122 wound with the end of the wire 2. That is to say, the installation section 141 of the conductive pin 14 is placed in the channel 121, and the wire connecting section 142 then protrudes from the exit 123 and becomes disposed correspondingly to the bridge pin 122. The welding step 43 is then performed, in which the wire 2 and the wire connecting section 142 of the conductive pin 14 are welded to form an electrical connection. The welding material 6 applied for the welding process may completely enclose the bridge pin 122, or may only connect the wire 2 with the conductive pin 14. For example, the welding material 6 may be tin. Thus, the wire winding method of the present invention is complete. In continuation, in the conductive pin inserting step 42 according to one embodiment, after the wire 2 is settled, the core 3 may be assembled with the wire spool structure 1, and may serve as a base and be placed in an apparatus to perform the subsequent step of inserting the conductive pin 14. Further, the direction according to which the conductive pin 14 of the present invention is inserted into the channel 121 may be correspondingly adjusted according to manufacturing requirements. Preferably, as shown in FIG. 5 and FIG. 6 of the present invention, the conductive pin 14 is inserted into the channel 121 from the exit 123 corresponding to the bridge pin 122 wound with the end of the wire 2. Thus, the part of the wire connecting section 142 of the conductive pin 14 corresponding to the bridge pin 122 is protruded to be welded with the end of the wire 2.

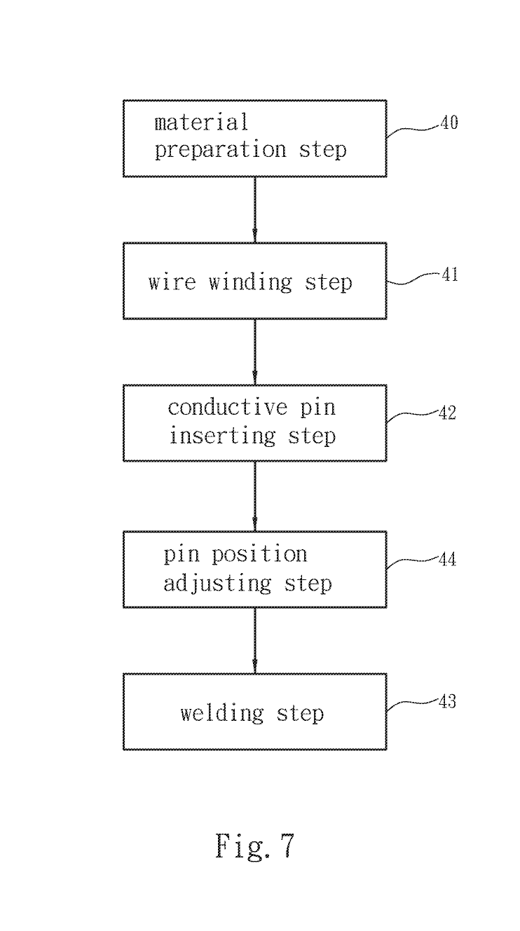

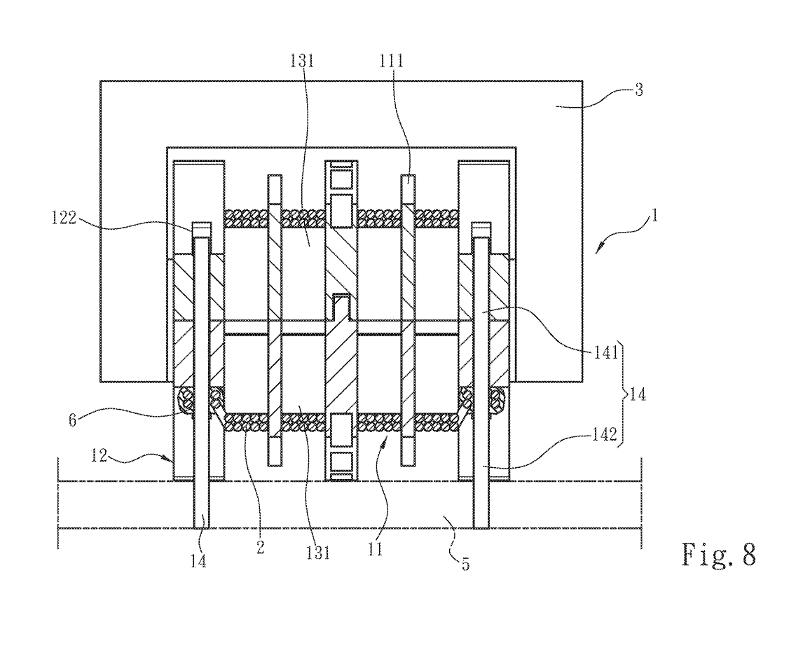

Referring to FIG. 7 and FIG. 8, in one embodiment, between the conductive pin inserting step 42 and the welding step 43, the method further includes a pin position adjusting step 44. In the pin position adjusting step 44, the conductive pin 14 is caused to protrude towards the bridge pin 122 to be able to be connected with the circuit board 5. Thus, it is ensured that the conductive pin 14 can be smoothly assembled with the circuit board 5 after the wire winding process is complete.

In conclusion, in the wire spool structure for facilitated wire winding and the wire winding method of the wire spool structure of the present invention, the wire spool structure includes at least one wire winding portion, a plurality of wire exit portions and a plurality of conductive pins. The wire exit portions are connected to one side of the wire winding portion. Each of the wire exit portions includes a channel penetrating the wire exit portion and having at least one exit, and at least one bridge pin integrally extended and formed from the wire exit portion and located at the exit of the channel to allow the wire to be wound thereon. The conductive pins are disposed correspondingly to the exits, respectively. Each of the conductive pins includes an installation section and a wire connecting section connected to the installation section. After an end of the wire is wound at the bridge pin, each of the conductive pins is inserted into the channel to locate the installation section in the channel, such that the wire connecting section protrudes from the exit to become disposed correspondingly to the bridge pin, and is welded with the wire by a welding material to form an electrical connection. Thus, winding issues caused by conductive pins in a conventional wire spool structure are solved.

What is claimed is:

1. A wire winding method of a wire spool structure, comprising steps of:
a material preparation step that provides a wire spool structure, the wire spool structure comprising at least one wire winding portion, a plurality of wire exit portions and a plurality of conductive pins; each of the wire exit portions comprising a channel penetrating the wire exit portion and having at least one exit, and a bridge pin integrally extended and formed from the wire exit portion and located at the exit of the channel to allow the wire to be wound thereon;
a wire winding step that provides a wire and winds the wire for at least one turn on the wire exit portion to cause an end of the wire to be wound on the bridge pin;
a conductive wire inserting step that inserts one of the conductive pins into the channel to cause the installation section of the conductive pin to locate in the channel, and to cause the wire connecting section of the conductive pin to protrude from the exit to become disposed correspondingly to the bridge pin; and
a welding step that welds the wire connecting section of the conductive pin with the wire by a welding material to form an electrical connection.

2. The wire winding method of a wire spool structure of claim 1, between the conductive wire inserting step and the welding step, the method further comprising a pin position adjusting step that causes the wire connecting section of the conductive pin to protrude from the exit of the channel to be able to be connected to a circuit board.
